(19) United States
(12) Patent Application Publication
(10) Pub. No.: US 2007/0244870 A1
(43) Pub. Date: Oct. 18, 2007

(54) Automatic Search for Similarities Between Images, Including a Human Intervention

(75) Inventors: Christophe Laurent, Hede (FR); Thierry Dorval, Paris (FR)

Correspondence Address: Thomas Langer;Cohen Pontani Lieberman & Pavane, 551 Fifth Avenue, Suite 1210, New York, NY, 10176, US

(73) Assignee: Franc Telecom, Paris (FR)

(21) Appl. No.: 11/630,716

(22) PCT Filed: Jun. 23, 2004
(86) PCT No.: PCT/FR04/01563

§ 371 Date: Dec. 21, 2006

(51) Int. Cl. G06F 17/30

(52) U.S. Cl. 707/3

(57) ABSTRACT

The present invention proposes a method and a device for improving the relevance of images shown to a user during an image search phase in an indexing engine. The method includes firstly a step of evaluation by a user of the method or the device of the relevance or the irrelevance followed by a step of associating a relevance value with each of the images declared relevant (or irrelevant), creating an influence zone (or influence field) around the image concerned, all these fields then being accumulated. The images finally shown to the user are those having the highest relevance values.

### TECHNICAL FIELD

The subject matter of the present invention relates to searching images to find a visual similarity between images contained in an image base and at least one request image.

This similarity search is usually conducted by a search engine or indexing engine running on a processor, the images typically being stored in a digital memory, and a terminal is used to show the result to a user of the search method, who is able to intervene in the process through the intermediary of interfaces (keyboard, mouse, etc.).

An objective of the invention is to attempt, in an automatic image search, to take into account the subjectivity of the visual perception of the user when searching for a similarity between images and a request image.

The main difficulty lies in the fact that, being deterministic, image (or other) search algorithms always converge from the same request towards the same set of results, whereas a user whose subjectivity is involved when comparing images, yields a result that may differ from that of another user. By way of illustration, a tumor search engine in a medical imaging application could execute a search entirely automatically, given that there is very little room for subjectivity, whereas sorting holiday photos may involve more subjectivity, given that the request is of a generalist kind. At a level linked to a high degree of subjectivity, any attempt at deterministic visual similarity calculation is therefore bound to fail to a greater or lesser degree according to the relevance of the image comparison processes.

To alleviate this problem, human intervention (i.e. intervention by the user of the search system) in order to reduce the skew of the search remains essential.

The system will then learn the idea of similarity specific to a given user by adjusting the intrinsic parameters of the similarity calculation engine through the actions of the user, who approves or does not approve the results shown during the search phase.

This learning phase is also known as relevance feedback.

These adjustments of the parameters intrinsic to the engine are small in that they modify only the relative importance assigned to the various descriptors. Thus relevance feedback can only refine a search and not under any circumstances alleviate a poor choice of descriptors.

To illustrate the learning phase concept, consider the visual similarity function Dᵢ associated with a user U₁ and two images I₁ and I₂ from the base. With no relevance feedback (i.e. without being able to distinguish U₁ from U₂), we have D₁(I₁, I₂)=D₂(I₁, I₂)=Dᵢ(I₁, I₂). Taking this equality as a postulate therefore denies the subjectivity of the person. It will therefore be necessary to consider the results given by U₁ and U₂ to distinguish D₁(I₁, I₂) from D₂(I₁, I₂). Pushing this line of thinking further forward, it may also be considered that D_{1,t1}(I₁, I₂)≈D_{1,t2}(I₁, I₂), where D_{1,t1} corresponds to the similarity perceived by the user U₁ at time t₁, thereby taking into account the fact that a user's idea of visual similarity may vary over time. This example shows the complexity of simulating this concept accurately.

The only way to take the subjectivity of the user into account would therefore seem to be for the user to set the parameters of the processing loop.

It is generally considered that the similarity between two images is merely a weighted sum of the differences between their descriptors. Consider three large families of descriptors: colour (C), texture (T) and shape (F). During the similarity calculation process, the relative importance of the descriptors is weighted. Accordingly, the similarity function D(I₁, I₂) can be written:
D(I₁,I₂)=αC(I₁,I₂)+βT(I₁,I₂)+γF(I₁,I₂)

The problem of assigning values to the weighting coefficients then arises.

It is at this level that human subjectivity intervenes.

### PRIOR ART

Some systems are based on developing a man-machine interface for adjusting the weight to be assigned to each descriptor during the search phase. This approach has numerous drawbacks, however:
the search process becomes a great burden for the user, as the greater the required accuracy, the more parameter values the user has to specify;
a good understanding is necessary of how the indexing engine uses the coefficients; unfortunately this is very rarely true, particularly for a consumer application;
the user has no idea of the statistical distribution of the signatures in the image base and is therefore unable to take account of them when adjusting the parameters;
modeling one's own visual assessment by a series of digits is exceedingly difficult.

It is to remedy these problems that current relevance feedback methods have been developed.

Referring to FIG. 1, a conventional image search with relevance feedback comprises:
a preliminary first step 1 of searching for similar images;
a second step 2 during which the user is shown N responses that the system deems relevant according to automatic criteria implemented by the authors of the application. A first method consists in the user selecting from the response images the images that seem to the user to correspond best to the initial request (see for example Y. Chen at al. “One-Class SVM for Learning in Image Retrieval”, in IEEE International Conference on Image Processing, Thessalonika, Greece 2001). In a second method, the user may, in contrast, specify those images the user deems not to be relevant (see for example Y. Rui at al. “Relevance Feedback: A Power Tool for Interactive Content-Based Image Retrieval”, in Storage and Retrieval for Image and Video Databases (SPIE) pages 25-36, 1998). In a third method, such as that described by Y. Rui at al. “A relevance Feedback Architecture in Content-Based Multimedia Information” (IEEE Workshop on Content-Based Access of Image and Video Libraries, pages 82-89, Puerto Rico, June 1997), the user is requested to classify all images returned by the system. Conversely, in “Incremental Relevance Feedback” by I. J. Aalbersberg (Proceedings of the Fifteenth Annual International ACM SIGIR Conference on Research and Development in Information Retrieval, pages 11-22, Copenhagen, 1992), the engine shows only one document to the user and prompts the user to confirm or negate its relevance immediately. “Interactive Evaluation of the Ostensive Model Using a New Test Collection of Images with Multiple Relevance Assessments” by I. Campbell (Information Retrieval, 2(1): 89-114, 2000), describes a tree type interface. To each node there corresponds an image, and if the user judges that image relevant, the user then unfolds the corresponding branch and in this way browses within the image base.
a third step 3 of relevance feedback. Since the ways of orienting the request are highly intuitive for the user, they enable the application to direct the search more accurately during the next relevance feedback step. The object of a relevance feedback algorithm is therefore to make the best possible use of feedback from the user to model that user's subjectivity, so to speak.

The relevance feedback must therefore enable the application to work towards the ideal image deemed to represent what the user wants.

Let Q₀ denote the initial request image and \vec{Q}₀ denote its signature (or its visual characteristics as defined by a set of particular descriptors) in the descriptor space.

It is to be noted that a descriptor space is defined by axes each giving the importance of one of the particular descriptors in an image, the images being generally positioned within this space.

In the same way, let Iₚⁱ and I _{p̅}ⁱ denote relevant and irrelevant images, respectively, specified by the user.

A first type of prior art relevance feedback is that used by the Rocchio algorithm (J. Rocchio “Relevance Feedback in Information Retrieval”, pages 313-323, in The Smart Retrieval System—Experiments in Automatic Document Processing, Gerard Slaton, Prentice-Hall, 1971).

It is a question here of shifting the point modeling the request image in the descriptor space towards an “ideal” second request image, which need not necessarily exist in the base.

A second type of prior art relevance feedback, also known as the standard deviation method, is based on a reweighting algorithm. See, for example, “Image Retrieval by Examples” by R. Brunelli and O. Mich (IEEE Transactions on Multimedia, 2(3): 164-171, 2000).

It is a question here of taking account of the shape of the statistical distribution of the user's feedback on the images. For example, if the standard deviation of the distribution of the responses where the user deems the image relevant is high for the descriptor i, this undoubtedly means that this descriptor does not have a major discriminatory role. It will therefore be necessary to assign it a low weighting. Thus the weighting of this descriptor i is inversely proportional to its standard deviation.

If the function of similarity between two signatures is considered to be based on a spherical shape using the Euclidean norm, this reweighting then amounts to expanding or contracting the principal axes of the descriptor space in particular by considering the following matrix definition of the distance between two vectors \vec{I} and \vec{Q}:
D(\vec{I},\vec{Q})=(\vec{I}−\vec{Q})^{T}A(\vec{I}−\vec{Q})
where A is the symmetrical similarity matrix whose dimension is equal to the number of descriptors defining the space and may be written A=[aᵢⱼ] with aᵢⱼ≧0 and aᵢⱼ=aⱼᵢ. The isosurface of this distance is then an ellipse.

As for relevance feedback, Y. Shikawa at al. in “Mindreader: Query databases through multiple examples” (International Conference on Image Processing, Rochester, N.Y., USA, September 2002) and Y. Rui at al. in “A Novel Relevance Feedback Architecture in Image Retrieval” (ACM Multimedia (2), pages 67-70, 1999), also propose to modify the coefficients of the correlation between the various descriptors in order to refine the modeling of the visual similarity perception space.

Obviously combining these approaches with that of Rocchio may be envisaged.

Generally speaking, all these approaches (Rocchio and reweighting) consist in geometrically deforming the descriptor space in order to approximate the subjective perceptual space of the user with the greatest possible relevance. These deformations are characterized by a modification of the associated metric. Furthermore, these geometrical models are unimodal, which is a limitation of the perceptual model (see for example “Indexation d'images par le contenu et recherche interactive dans les bases generalists” [“Indexing of images by content and interactive search in generalist bases”] by J. Fournier at al., Ph.D. thesis, Cergy-Pontoise University, October 2002).

A third type of prior art relevance feedback is based on probabilistic models.

In a first probabilistic model known as the PicHunter model (or system), each image of the base is assigned a probability value that is re-assessed on each relevance feedback iteration. This value represents the a priori probability P(Iᵢ=I_{q}) that the image Iᵢ from the base is the user's request image I_{q}.

This model takes into account the record of the actions Aₜ of the user faced with the set of images Dₜ that were shown to the user on the relevance feedback iteration t, to obtain a probability that the image Iᵢ is the image I_{q}.

It is then a question of calculating the probability of the choice of the user faced with the images that have been shown to the user, using a user model that starts from the principle that this choice is independent of the user. The results of psychophysical experiments conducted by the authors are used for this purpose.

The probability calculation includes in particular the calculation of the following function:

$$\frac{1}{1 + {ⅇ}^{\frac{d ( {I}_{1} , {I}_{q} ) - d ( {I}_{2} , {I}_{q} )}{σ}}}$$

in which d(Iᵢ, I_{q}) is the distance between the respective signatures associated with I₁ and I_{q}, and σ is an empirical parameter. The a priori probability that each of the images from the base is the image I_{q} can then be determined and those having the highest scores shown to the user.

A second probabilistic model is the Bayesian decision model (see for example “Relevance Feedback and Category Search in Image Databases” by C. Meilhac at al. in IEEE International Conference on Multimedia Computing and Systems, Florence, Italy, June 1999), which categorizes the whole of the base into two classes: relevant and irrelevant.

Once again, it will be a question of determining the a posteriori probability of each of the images Iᵢ from the base belonging to the Class Cᵣ (relevant) or the Class Cₙ (irrelevant). This method does not seek to make any assumption as to the shape of the statistical distribution of the image descriptors. It is therefore a non-parametric method.

The probability densities are determined using a Gaussian Parzen core.

The choice to use Parzen cores to determine the probability density dispenses with making any hypothesis as to the shape of the distribution but necessitates a large number of examples. The required number increases exponentially with the number of dimensions of the descriptor space. Moreover, the calculations used are applicable only on the assumption that all the descriptors are independent, which represents a major limitation of this model.

A third probabilistic model is based on support vector machines (SVM).

Here it is a question of effecting relevance feedback through a classification type approach. An attempt is made to separate the base into two groups: relevant images and irrelevant images.

The use of a perceptron type neural network would enable this classification to be effected by evaluating the position of the points relative to the separator hyperplane in the descriptor space. The drawback of this type of method is that it returns a binary result: relevant C_{R} or irrelevant C_{N}.

The use of vector support machines (SVM) alleviates this drawback by proposing also to supply by way of additional information the distance to the hyperplane. This method seeks to construct an optimum hyperplane, i.e. one maximizing the distance between the plane and the learning points.

However, the calculations employed in this method are complex, even if they are simplified by using a Gaussian type core function embodying the concept of the distance between two vectors (and therefore of similarity) in the descriptor space as well as an empirical parameter.

Thus when applying SVM to relevance feedback, the algorithm is used as a classifier. By choosing relevant images (see “One-Class SVM for Learning in Image Retrieval” by Y. Chen at al., in IEEE International Conference on Image Processing, Thessalonika, Greece, 2001) or irrelevant images (see “Support Vector Machine for Learning Image Retrieval” by L. Zhang at al. in IEEE International Conference on Image Processing, Thelassonika, Greece, 2001), the user then initializes the learning base supporting the classification.

All the techniques described above still have limitations.

The Rocchio and reweighting techniques use a major hypothesis: that images that the user considers similar are relatively close together in the descriptor space. Unfortunately, making this assumption requires descriptors that perfectly reflect human perception, which is never true. Moreover, reweighting is generally effected by assigning preference to one direction in the descriptor space, i.e. to a particular descriptor. Consequently, these techniques have to be iterated a large number of times before reaching what the user wants.

Bayesian methods and methods based on SVM classify images in the descriptor space. In this regard, these are learning methods involving a great deal of complex calculation.

It is also important to emphasize the failings of most of these methods:
History. Very few of these methods take account of the user's past choices in terms of relevant or irrelevant images.
Changing user objectives. The existing methods do not take account of this criterion, thus preventing the user from browsing within the base.
Multimodality. As already mentioned, images that are close in the sense of visually similar are not necessarily so in the sense of the descriptors. It is therefore necessary to have multiple sources of relevance or irrelevance in the descriptor space.
Irrelevance. None of the existing methods take account of the irrelevance of images.

A first objective of the present invention is to provide a simple way to apply relevance feedback in the context of a search for similarity between images and at least one request image.

A second objective of the invention is to apply relevance feedback by means of a non-parametric method with no influence whatsoever on the descriptor space or the distances between images.

A third objective of the invention is for relevance feedback to take account of negative responses from the user (i.e. feedback indicating the irrelevance of images shown to the user).

A fourth objective of the invention is the judicious taking into account by the algorithm of user feedback from previous iterations. In particular, the algorithm should to some degree take account of possible changes to the choices made by the user during the search phase.

A fifth objective of the invention is to have an intelligent way to show the selected images to the user, so as to have a more pertinent presentation than merely presenting a list of images.

A first aspect invention achieves these objectives in particular by proposing an image search method of finding a visual similarity between images contained in an image base and a request image, each image having a particular signature (or a set of particular descriptors), elements of the images and an element of the request image being positioned in a descriptor space defined by axes each giving the importance of one of the particular descriptors in an image element, characterized in that it comprises the iterative execution of the following steps:

(a) evaluation by a user of a visual relevance or a visual irrelevance to the request image of an image from a plurality of images that are shown to the user;

(b) calculation of a relevance value assigned to each image, comprising:
calculation of a field of influence extending around each element of each image evaluated during the step (a), so that the absolute value of that field of influence decreases on moving away from the evaluated image element concerned in the descriptor space;
for each image element, summation of the values of the various fields of influence affecting the image element concerned, thereby assigning each image element a relevance value for the current iteration;

(c) selection by the indexing engine of the images having the highest relevance values in order to show them to the user again during the next iteration.

Particular features of this image search method include:
in a first configuration, said image elements are the images themselves in their entirety;
in a second configuration, said image elements are image objects, each image consisting of a plurality of particular objects, and the step (b) further comprises a final operation consisting in a summation of the (previously calculated) relevance values of the various objects constituting the image concerned, thereby assigning each image the relevance value required for the current iteration;
if an image is evaluated as being relevant during the step (a), the field of influence calculated during the step (b) has a positive value;
if an image is evaluated as being irrelevant during the step (a), the field of influence calculated during the step (b) has a negative value;
the step (b) further comprises the summation, for each image element, of the relevance values of the current iteration with relevance values of preceding iterations;
the step (b) further includes, before the operation of summing the relevance values of the current iteration with relevance values of preceding iterations, an operation of weighting the relevance values for each image element in order for the attenuation of their influence on the result of that summation to be proportional to the age of the iterations from which they come;
the weighting of the relevance values assigned to each element of the request image is different from the weighting of the relevance values assigned to each element of the other images, in the sense that the attenuation of their respective influence on the result of the summation operation is inversely proportional to their age;
the step (b) further comprises a weighting step that assigns a different weight to the fields of influence according to whether the associated image was evaluated as being relevant or irrelevant during the step (a);
during the step (a) the user further assigns a relevance or irrelevance level to each image that the user evaluates and the extent of each field of influence calculated during the step (b) is proportional to the absolute value of that relevance or irrelevance level;
the different images selected during the step (c) are shown to the user in an order taking account of the relevance values assigned to them during the step (b);
the method further comprises, prior to the iteration steps, automatic evaluation of a visual similarity of different images to the request image; and selection of a particular number of images evaluated as being the most similar to the request image, those images then being the images shown in the step (a).

A second aspect of the invention proposes a device for implementing said method with or without the features listed above.

The invention also proposes a computer program including coding means for implementing the proposed method.

Other aspects, objects and advantages of the present invention will become more clearly apparent on reading the following detailed description of the use of preferred methods and devices in accordance therewith, given by way of non-limiting example and with reference to the appended drawings, in which:

FIG. 1 is a very general representation of the steps of a method of searching images including relevance feedback.

FIG. 2 represents the evolution in time (or over successive iterations) of the image search region in the descriptor space selected as the framework for implementing the method according to the invention.

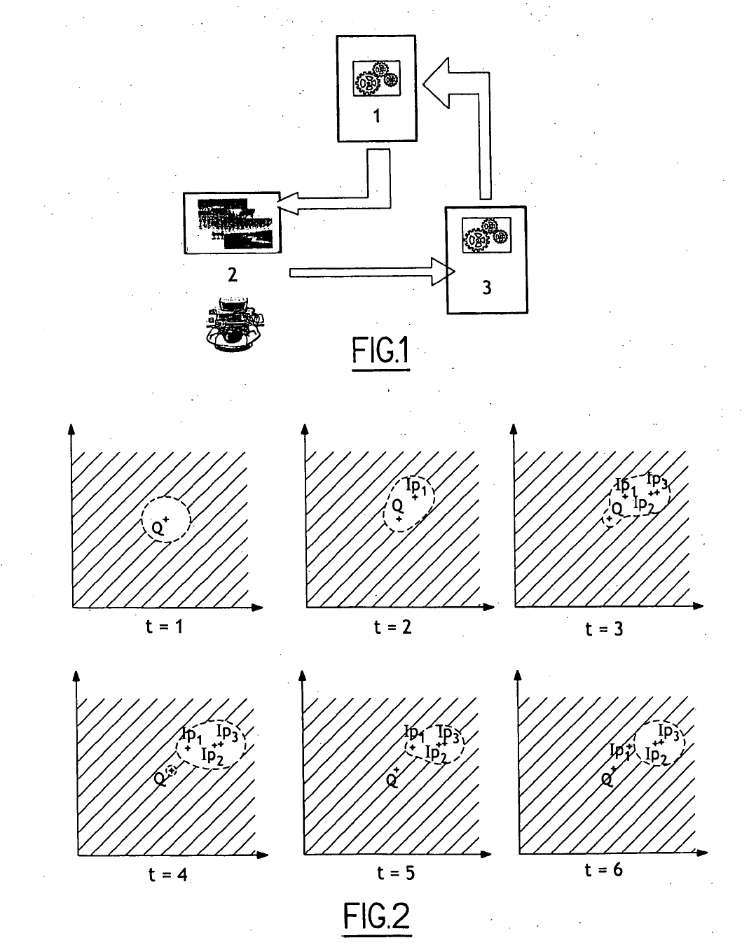

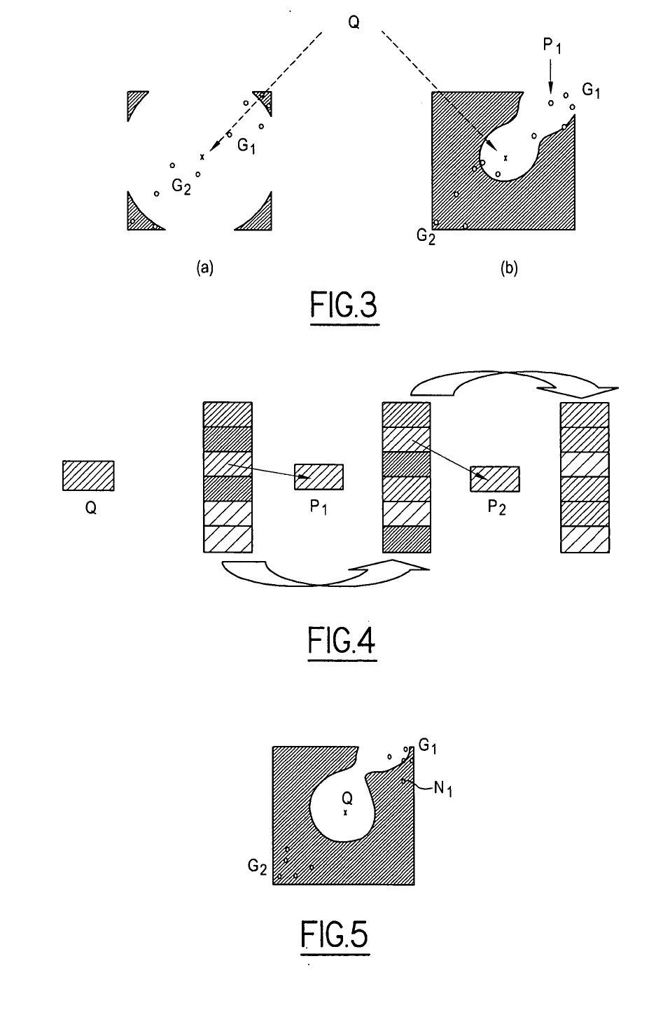

FIGS. 3 and 4 represent one embodiment of an image search method according to the invention in the situation where the feedback from the user is positive. FIG. 3 is a graphic representation of images in a two-dimensional descriptor space.

FIG. 5 represents an embodiment of an image search method according to the invention in the situation where the feedback from the user is negative in a graphical representation of images in a two-dimensional descriptor space.

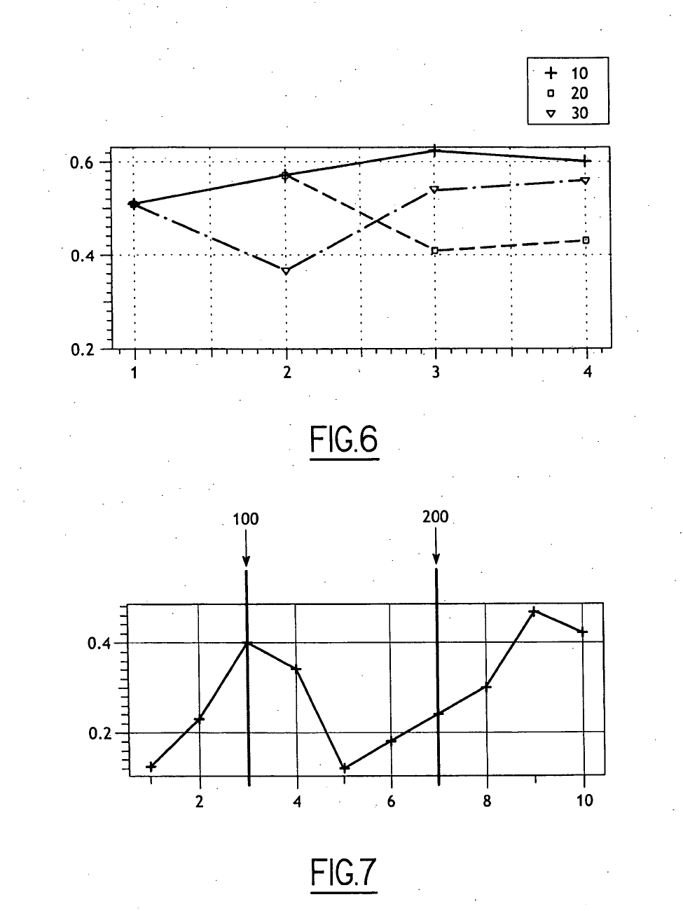

FIG. 6 represents the synthesis of experimental results showing the influence of the nature of the feedback (negative and/or positive) from the user on the relevance obtained by the method according to the invention.

FIG. 7 represents the synthesis of experimental results showing the influence of the changing objective of the user on the relevance obtained by the method according to the invention.

In accordance with the invention, the images are stored in an image base.

That image base may be divided into image sub-bases each defining a group of images for a particular truth terrain.

According to the invention, images or image objects (also referred to generically as “image elements) have a particular signature, in other words are described by a set of particular descriptors.

These image elements are positioned in a descriptor space defined by axes each specifying the importance of one of the particular descriptors in an image element. The image elements are therefore represented by points in the descriptor space, each therefore having a position characterizing the signature of the image element concerned in the descriptor space used (see FIG. 2 for example).

The method according to the invention advantageously comprises the following steps, executed iteratively until a result is obtained that is satisfactory or presumed to be satisfactory:

(a) evaluation by a user of a visual relevance or a visual irrelevance of an image from a plurality of images that are shown to the user, relative to a request image;

(b) relevance feedback;

(c) selection of the images having the greatest relevance, to show them to the user again on the next iteration.

During the step (a), the user is therefore shown, for example on a screen type display terminal, a number of images to which the user must assign a value corresponding to the user's judgment as to the relevance of the responses that are shown to the user.

In the context of the invention, there will be chosen a step (a) (consisting in intervention of the user in the search loop) during which the user will have the choice of declaring an image relevant or irrelevant. The user will typically assign a positive value for relevance and a negative value for irrelevance.

Of course, the invention provides for refining the type of choice given to the user, who can also assign a relevance or irrelevance level to each image that the user assesses.

In all cases, the relevance feedback step (b) will take account of the evaluation of the relevance of a few of the images that are shown to the user to influence the relevance of all the images from the image base or sub-base concerned.

The relevance feedback of step (b) calls directly for action by the user and waits for instantaneous feedback from the user. This situates the process at a critical point and, to be operative in real time, necessitates a simple implementation of the method according to the invention. Given the size of the descriptor space to be worked in and the large number of images that a base or a sub-base may contain, this aspect is far from trivial and can quickly lead to impracticalities. For this reason, in order not to exceed a critical complexity, it is desirable to evaluate the evolution of the associated complexity at each critical step of the algorithm.

The relevance feedback step (b) includes calculation of a relevance value assigned to each image, comprising:
calculation of a field of influence extending around each element of each image evaluated by the user during the step (a), so that the absolute value of that field of influence decreases on moving away from the evaluated image element concerned in the descriptor space;
for each image element, summation of the values of the various fields of influence affecting the image element concerned, thereby assigning each image element a relevance value for the current iteration.

For reasons of simplicity of use and portability, the relevance feedback process must be seen as being complementary to a conventional image search. To this end, it may operate as an independent portion of a more extensive process.

These fields of influence then define a search space (for images in the field of influence of an image evaluated as relevant during the step (a)), a non-search space (for images in the field of influence of an image evaluated as irrelevant during the step (a)), or an overlap space if a non-search space overlaps a search space.

The invention can therefore lead to splitting of the originally unique search space (centered around the request image) into a plurality of (non-connected) search spaces, if two elements are designated as relevant at one stage of the search but are far apart in the descriptor space, thereby causing multimode partitioning of the descriptor space.

Let N_{rel.} denote the number of images designated as relevant by the user and N _{r̅e̅l̅.̅} denote the total number of negative feedback responses (i.e. images designated as irrelevant by the user). The sum of these two types of images is denoted N_{fbk.}. A simple search then corresponds to the situation where N_{rel.}=N _{r̅e̅l̅.̅}=0.

Now let E denote the set of objects or images in the relevance feedback. This set is made up of sets E_{rel.}, E _{r̅e̅l̅.̅} and Q respectively designating the relevant images, the irrelevant images and the initial request image. Thus we have E=E_{rel.}∪E _{r̅e̅l̅.̅}∪Q. Eₜₒₜ denotes all the images of the base or sub-base.

In the initial situation (i.e. on iteration 0 or at time t=0, t being incremented by 1 on each iteration), we have:
Vᵢ(t=0)=τ_{Q}·e^{-d(i,Q)}
in which τ_{Q} is a weighting assigned to the request image Q.

The images retained as being similar to Q are then the k images having the highest relevance values. The set of those images is denoted E_{show}(N_{show}) where N_{show} represents the number of images shown to the user. To simplify the notation, this set will be designated E_{show}.

Accordingly, in the initial situation, V(i) represents the simple value of the similarity of the image i relative to the request image Q. At this time, the user has the option of designating within the set E_{show} the images that the user judges relevant or irrelevant, before relaunching the search. The calculation of Vᵢ(t), iεEₜₒₜ is then written:

$${V}_{i} ( t ) = {τ}_{Q} ( t ) \cdot {ⅇ}^{- d ( i , Q )} + {\sum }_{k = 1}^{{N}_{rel}} {τ}_{{P}_{k}} ( t ) \cdot {ⅇ}^{- d ( i , {P}_{k} )} - {\sum }_{k = 1}^{{N}_{\overline{rel}}} {τ}_{{N}_{k}} \cdot {ⅇ}^{- d ( i , {N}_{k} )} \qquad ( 1 )$$

where τ_{P}_{ₖ} and τ_{N}_{ₖ} are the respective weights of the images that have been evaluated by the user as being relevant and irrelevant, respectively. In the particular situation where, as well as making a choice as to the relevance or the irrelevance of images that are shown to the user, the user has the option of assigning a relevance level (for example 1/4, 3/4 and −4/4 for three images that are shown to the user in the context of a relevance level notation on a scale of 1 to 4), new weighting coefficients could be introduced for each level of relevance, for example, so that the evaluated levels with the highest absolute values have the most influence on the final result. It will also be possible to operate on the expression of the potential (e^{-d(i,I}) itself.

The determination of the values of Vᵢ(t)ε [symbol] necessitates no normalization. The set of these values will simply be sorted into increasing order and only the k highest values retained.

Accordingly, the particular situation in which there are only irrelevant images in the loop continues to be meaningful. In fact, in this situation, the images or objects proposed to the user will be the images at the greatest distances from the areas created by the irrelevant objects. In these circumstances the algorithm does not predict a relevant image, but rather a set of “least irrelevant” images.

In the context of the invention, the emphasis will rather be on not considering the feedback evaluated (during the step (a)) as being relevant in the same way as feedback evaluated as being irrelevant. In fact, recent research (see for example Y. Chen at al. “One-Class SVM for Learning in Image Retrieval”, in IEEE International Conference on Image Processing, Thessalonika, Greece 2001) has shown that it would certainly be incorrect to consider positive (i.e. relevant) feedback and negative (i.e. irrelevant) feedback in the same way, because (on the theory that the user does not change his or her mind during the process) positive feedback is semantically linked whereas negative feedback has no a priori reason to be semantically linked. It is therefore preferable for the relevance feedback algorithm to take account of the fact that positive and negative feedback from users do not convey the same type of information. Positive and negative feedback will therefore be processed asymmetrically. This can be achieved in the formula (I) by making the weights τ_{Nk} and τ_{Pk} different, for example.

Each image inserted into the set Eₜₒₜ therefore creates a zone or field of influence around its position in the descriptor space. Its influence is either positive for a relevant image or negative for an irrelevant image. Accordingly, the calculation of the N_{show} new images shown to the user will depend on the topology of the zone of influence created by the summation of the zones associated with the set of images found in the set E.

The calculation of the relevance value associated with the image of index i then depends on the set of images from the set E_{rel.} assigned a positive coefficient and of the images from the set E _{r̅e̅l̅.̅} assigned a negative coefficient reflecting the irrelevant character of that group.

There are optionally introduced into the various weightings denoted τᵢ (i=Q, Pₖ or Nₖ) in the formula (I) a variable of evanescence in time (or more accurately in accordance with the age of the iterations) that will limit the time span of an event, thereby assigning a lifetime to an image relevance value in the relevance feedback. This weighting will therefore be denoted τᵢ(t), giving in particular the lifetime of the image i in the iteration t, t being incremented on each search.

In these circumstances, there is associated with each image iεE_{tot.} a relevance value Vᵢ(t) evaluated as a function of its lifetime at the time t and the relative positions of the images of the set E. We then obtain:
Vᵢ(t)=F(i,t)
where F is a decreasing monotonous function. In the initial situation where t=0:
Vᵢ(t=0)=τ_{Q}(t=0)·e^{-d(i,Q)}

The images retained as being similar to Q are then the k images having the highest relevance values. The set of those images is denoted E_{show}(t, N_{show}) where N_{show} represents the number of images shown to the user. To simplify the notation, this set at time t will be denoted E_{show} (t).

The calculation of Vᵢ(t), iεEₜₒₜ is then written:

$${V}_{i} ( t ) = {τ}_{Q} \cdot {ⅇ}^{- d ( i , Q )} + {\sum }_{k = 1}^{{N}_{rel}} {τ}_{{P}_{k}} \cdot {ⅇ}^{- d ( i , {P}_{k} )} - {\sum }_{k = 1}^{{N}_{\overline{rel}}} {τ}_{{N}_{k}} \cdot {ⅇ}^{- d ( i , {N}_{k} )} \qquad ( 2 )$$

In one particular embodiment, on each iteration, the lifetime associated with an image from the set E decreases by one unit. When it reaches zero, it is removed from the list.

The request image continues to play the role of positive (relevant) feedback. Its lifetime τ_{Q}(t) may then be different from that of each of the other images from the base or sub-base. Accordingly, because of the specific character of the request image, the lifetime τ_{Q}(t) of the request image may be greater than the lifetime τ of each of the other images from the base or sub-base.

Using a lifetime for all the images in the relevance feedback takes account of the medium-term memory aspect of the learning process.

What is understood here by “medium-term memory” is defined in opposition to:
short-term memory, taking account of only the latest relevance feedback, as is regularly the situation in search engines;
long-term learning seeking to model the user's concept of similarity by retaining in memory actions effected not only during the current request but also during all past requests. Although seductive, this method is again based on the theory that the user will not change his or her mind during the search.

Accordingly, an image will play a role only temporarily and will thus enable the user to modify a choice during the image search phase. In fact, this relevance lifetime assigned to the images thereby assigns a learning inertia to the indexing engine enabling this possible change of direction of the user to be taken into account. In fact, in the present situation, an image designated as relevant at time t may no longer be designated as relevant at time t+τ, and may even become undesirable in the worst-case scenario.

Finally, the temporal variables will be reset to zero at the start of each new complete search (i.e. on designating a new request image).

FIG. 2 represents the evolution of the search zone (inside the dashed lines) for images having a relevance value greater than a threshold enabling them to appear in the set E_{show}(t).

At t=1, a zone of influence (i.e. an unshaded zone in FIG. 2) is initially defined around the request image in this two-dimensional descriptor space, typically the field of influence associated with a spherical symmetry around the point representing the request image Q.

At t=2, the user evaluated the image Iₚ₁ as being relevant during the step (a). The consequence of the relevance feedback is to stretch the zone of influence towards the position of the image Iₚ₁ in the descriptor space.

At t=3, the user evaluated the images Iₚ₂ and Iₚ₃ as being relevant during the step (a). The consequence of the relevance feedback is to stretch the zone of influence towards the positions of the images Iₚ₂ and Iₚ₃ in the descriptor space.

At t=3 to 6, the user confirms the user's evaluation of the 3^{rd} iteration (the relevance of the images Iₚ₂ and Iₚ₃) during the step (a). There is therefore finally obtained a zone of influence centered on the images Iₚ₂ and Iₚ₃ that is representative of the similarity of the images to the request image Q in the sense in which the user means it.

Finally, this step (c) of the method according to the invention consists in the indexing engine selecting the images having the highest relevance values in order to show them to the user again during the next iteration.

The showing of the images selected in this way is optionally not random, but in a particular order. The images could be shown in the order from the most relevant to the least relevant, for example.

Accordingly, this approach may have advantages such as:
directing the user faster to images that satisfy the user;
reducing the influence on the user's choice of adjacent images shown to the user. The concept of similarity is in fact also related to its environment. The same user may in fact designate a first image as being relevant when it is surrounded by certain images and as irrelevant in a different context.

One variant of the invention consists in no longer positioning the images in the descriptor space, but instead positioning objects of which those images are composed.

This relationship is of particular interest in the context of a relevance feedback process, the concept of similarity between two images being intimately linked to the similarity of the various objects that compose it. The relevance feedback stage is then the ideal stage for effecting the link between the objects and the overall images.

To this end, each time that the user selects a relevant image Pₖ in the images space, all of the objects composing that image are considered as relevant and treated as such. The user then has access to all of the k objects having the highest relevance value V(i).

The processing then comprises the two operations referred to above during execution of the step (b), said “image elements” then being “image objects” here, and furthermore with a final operation consisting in a summation of the (previously calculated) relevance values of the objects constituting the image concerned, thereby assigning each image the relevance value required for the current iteration.

Thus the algorithm will program all the objects common to all the images selected by the user (the summation increasing the area of the zone of influence around them).

If the user decides to effect relevance feedback during an object request, they will be processed in the conventional way and will then confirm the high relevance value regions.

Particular Embodiment of the Invention in a Simple Case:

The evolution of a search in a simple case is described below. For this purpose, consider a space of two chromatic descriptors, namely the mean value of the Red and Green component (r, g). Two groups of objects positioned at the extremities of this space are placed artificially: a group G₁ of uniformly yellow images and a group G₂ of uniformly grey/black images. There is then selected as the initial request a medium grey image Q, which is therefore situated half-way between the two groups (see FIG. 3(a)). A conventional image search engine will propose by way of response to this request a set of images drawn from the groups G₁ and G₂ (see FIG. 4, first column). It is at this level that the user will be able to orient his or her choice with the assistance of relevance feedback. For this, the user designates a yellow image P₁ as being relevant (see FIG. 4). The method according to the invention then modifies the search area by calculating again the density at all points of the space (see FIG. 3(b)). The result supplied by the search engine is therefore closer to what the user wants (see FIG. 4, second column). If the user persists in this choice by again specifying the colour yellow (P₂), the result will then be a perfect match to this choice (see FIG. 4, third column).

Otherwise, if the user specifies a yellow image N₁ as being irrelevant, the area will tend to move away from this point (see FIG. 5), but nevertheless retaining a medium-term memory of the preceding choices.

Experimental Results

The subject of evaluating a relevance feedback system is problematic and rarely touched upon in the literature. In fact, it is a more complex problem than that of evaluating a simple search system. It is necessary to ask the basic question: what does a relevance feedback algorithm valorize? In the context of the invention, it is a question not only of evaluating the relevance of the images shown to the user but also of evaluating the capacity of that relevance to adapt to a change of the user's objective.

To this end, the Applicant has come down in favour of an empirical method based on the concept of relevance as experienced by the user. This value for the iteration t is denoted P(t). Each image designated a posteriori as relevant by the user is then assigned a value relative to its position within the set E_{show}(t). This value is inversely proportional to its classification rank. If N_{show} denotes the number of images shown and if an image Iᵢ is defined as being relevant, its contribution to P(t) will then be:
Pᵢ(t)=N_{show}−Rank(Iᵢ)

The total value of the relevance is then defined by the sum of all the contributions:

$$P ( t ) = \frac{{\sum }_{i = 1}^{{N}_{show}} δ ( {I}_{i} ) [ {N}_{show} - Rank ( {I}_{i} ) ]}{{\sum }_{i = 1}^{{N}_{show}} [ {N}_{show} - i ]}$$

in which the denominator serves as a normalization coefficient and δ(Iᵢ) has the value 1 if Iᵢ is considered relevant and the value 0 if not.

A base consisting of 2000 images and a truth terrain of 15 groups of 20 images constituting semantic formations were used for all the experiments. From this, it was possible to evaluate automatically the value δ(Iᵢ) relative to the truth terrain. i.e.:

$$δ ( {I}_{i} ) = \{ \begin{matrix}1 if {I}_{i} ∈ {G}_{k} \\ else , 0\end{matrix} \}$$

where Gₖ represents the group of k images of the truth terrain chosen for the current experiment.

This method takes into account the relevance of the classification effected by the engine according to the invention. It is primarily the evolution of the engine that is looked for, and this method appears the most propitious for this.

For reasons of simplicity of representation, two simple descriptors have been chosen here, namely:
a colour descriptor, based on the calorimetric mean of the image, calculated in the HSV colour space;
a texture descriptor \vec{f}=[μ₀₀, σ₀₀ . . . μ₃₅, σ₃₅] of dimension 24 (because there are 4 scales and 6 orientations), based on the use of Gabor filters (for more information on this see, for example: “Texture Features for Browsing and Retrieval of Image Data” by B. S. Manjunath and W. Y. Ma, in IEEE Transactions on Pattern Analysis and Machine Intelligence, 18(8): 837-842, August 1996).

Once again, there is no attempt here to assess the descriptors, but rather to note the adaptation power of the relevance feedback algorithm according to the invention.

The Applicant has repeated relevance feedback experiments for different categories of images.

The results are summarized in FIGS. 6 and 7, which show the evolution of the relevance (ordinate axis) during the course of the iterative process (the number of iterations is plotted on the abscissa axis).

FIG. 6 represents the evolution of the relevance P(t) as a function of the use of positive (i.e. relevant) feedback and/or negative (i.e. irrelevant) feedback.

The curve 10 gives the relevance result if the user is authorized (in the step (a)) to give positive and negative responses.

The curve 20 gives the relevance result if the user is authorized (in the step (a)) to give only negative responses.

The curve 30 gives the relevance result if the user is authorized (in the step (a)) to give only positive responses.

This curve shows that combining the two types of feedback (positive and negative) yields a better end result.

The use of only positive feedback does not lead to optimum results. In fact, positive feedback moves towards relevant images, but if an irrelevant image is nevertheless found in the zone of influence created by the N_{rel.} relevant images, then the irrelevant image will appear in the set E_{show}(t), which explains the lesser relevance result.

Using only negative feedback gives results of poorer quality. In fact, as previously indicated, negative feedback merely moves away from irrelevant images. To obtain a more relevant result, it would be necessary to push the relevance feedback process over a very large number of iterations at the same time as maintaining the entire history, i.e. by making t tend to infinity. This would then rule out taking into account a change of objective on the part of the user. Also, this result reinforces the idea encountered previously of not giving negative relevance feedback the same importance as positive relevance feedback.

FIG. 7 shows the quality of adaptation of the method according to the invention in the face of a change of the user's objective between two iterations. The same type of experimental procedure was used for this as before, simply by changing Gₖ during the experiment. In FIG. 7, the user makes two changes 100 and 200 of objective during the first ten iterations.

It is interesting to note that there is no latency at the time of the second change of objective. This is a particular instance of the search zone associated with the preceding choice broadly corresponding to that of the new selection.

The present invention is not limited to the image search process examples described above and encompasses any application corresponding to the inventive concept as it emerges from the present text and the various figures. Moreover, the present invention encompasses the image search device adapted to implement the method according to the invention.

1. An image search method of finding a visual similarity between images contained in an image base and at least one request image, each image being described by a set of particular descriptors elements of the images and an element of the request image being positioned in a descriptor space defined by axes each giving the importance of one of the particular descriptors in an image element, wherein the image search method comprises iteratively executing the steps of:
(a) evaluation by a user of a visual relevance or a visual irrelevance to the request image of an image from a plurality of images that are shown to the user;
(b) calculation of a relevance value of the at least one image, comprising:
calculation of a field of influence extending around each element of the at least one image evaluated during the step (a), so that the absolute value of that field of influence decreases on moving away from the evaluated image element concerned in the descriptor space;
for each image element, summation of the values of the various fields of influence affecting the image element concerned, thereby assigning each image element a relevance value for the current iteration that is proportional to how representative the value of the field is of a relevant image; and
(c) selection by the indexing engine of the images having the highest relevance values in order to show them to the user again during the next iteration.

2. The image search method according to claim 1, wherein said image elements are the images themselves in their entirety.

3. The image search method according to claim 1, wherein said image elements are image objects, each image consisting of a plurality of particular objects, and the step (b) further comprises a final operation consisting in a summation of the (previously calculated) relevance values of the various objects constituting the image concerned, thereby assigning each image the relevance value required for the current iteration.

4. The image search method according to claim 1, wherein:
if an image is evaluated as being relevant during the step (a), the field of influence calculated during the step (b) has a positive value; and
if an image is evaluated as being irrelevant during the step (a), the field of influence calculated during the step (b) has a negative value.

5. The image search method according to claim 1, wherein the step (b) further comprises the summation, for each image element, of the relevance values of the current iteration with relevance values of preceding iterations.

6. The image search method according to claim 5, wherein the step (b) further includes, before the operation of summing the relevance values of the current iteration with relevance values of preceding iterations, an operation of weighting the relevance values for each image element in order for the attenuation of their influence on the result of that summation to be proportional to the age of the iterations from which they come; and
wherein the weighting of the relevance values assigned to each element of the request image is different from the weighting of the relevance values assigned to each element of the other images, in the sense that the attenuation of their respective influence on the result of the summation operation is inversely proportional to their age.

7. (canceled)

8. The image search method according to claim 1, wherein the step (b) further comprises a weighting step that assigns a different weight to the fields of influence according to whether the associated image was evaluated as being relevant or irrelevant during the step (a).

9. The image search method according to claim 1, wherein during the step (a) the user further assigns a relevance or irrelevance level to each image that the user evaluates and the extent of each field of influence calculated during the step (b) is proportional to the absolute value of that relevance or irrelevance level.

10. (canceled)

11. The image search method according to claim 1, further comprising, prior to the iteration steps, the steps of:
automatic evaluation of a visual similarity of different images to the request image; and
selection of a particular number of images evaluated as being the most similar to the request image, those images then being the images shown in the step (a).

12. An image search device for finding a visual similarity between images contained in an image base and at least one request image, comprising a memory for producing an image database, optionally divided into image data sub-bases, and processing means adapted to position elements of the images and at least one element of the request image in a descriptor space defined by axes each giving the importance of one of the particular descriptors in an image element, each image having a set of particular descriptors, wherein the image search device further comprises the following means, used iteratively:
(a) a display terminal enabling the user to view images an input means enabling the user to enter the user's evaluation of the visual relevance or the visual irrelevance of at least one image from a plurality of images that are shown to the user relative to the request image; and
(b) means for calculating a relevance value assigned to each image, adapted to:
calculate a field of influence extending around each element of the at least one image evaluated during the step (a), from said input coming from said calculation means, so that the absolute value of that field of influence decreases on moving away from the evaluated image element concerned in the descriptor space;
for each image element, summing the values of the various fields of influence affecting the image element concerned, thereby assigning each image element a relevance value for the current iteration; and
(c) an indexing engine that selects the images having the highest relevance values in order to show them to the user again during the next iteration.

13. The image search device according to claim 12, wherein said image elements are image objects, each image consisting of a plurality of particular objects, and the calculation means are further adapted to execute a final operation consisting in a summation of the (previously calculated) relevance values of the various objects constituting the image concerned, thereby assigning each image the relevance value required for the current iteration.

14. The image search device according to claim 13, wherein the memory is further adapted to retain relevance values from preceding iterations and the calculation means are further adapted, for each image element, to sum relevance values for the current iteration with relevance values for preceding iterations, weighting relevance values for each image element beforehand, so that the attenuation of their influence on the result of their summation is proportional to the age of the iterations from which they come.

15. A computer program, characterized in that it includes coding means for executing the method according to claim 1.

16. The image search device according to claim 12, wherein the memory is further adapted to retain relevance values from preceding iterations and the calculation means are further adapted, for each image element, to sum relevance values for the current iteration with relevance values for preceding iterations, weighting relevance values for each image element beforehand, so that the attenuation of their influence on the result of their summation is proportional to the age of the iterations from which they come.
